(19) United States
(12) Patent Application Publication
(10) Pub. No.: US 2007/0133455 A1
(43) Pub. Date: Jun. 14, 2007

(54) System and method for multicasting through short range mobile-to-mobile communication

(76) Inventors: Ravi Kuchibhotla, Gurnee, IL (US); Brian K. Classon, Palatine, IL (US)

Correspondence Address: MOTOROLA, INC., 1303 EAST ALGONQUIN ROAD, IL01/3RD, SCHAUMBURG, IL, 60196, US

(21) Appl. No.: 11/301,952

(22) Filed: Dec. 13, 2005

(51) Int. Cl. H04Q 7/00

(52) U.S. Cl. 370/328; 370/312

(57) ABSTRACT

It is determined whether a first mobile station (102) should receive multicast communications. A control message is sent to at least one of the first mobile station (102) and a second mobile station (104). The control message initiates a mobile relay of multicast communications received at the second mobile station (104) to the first mobile station (102) via a proximal communication technology.

### FIELD OF THE INVENTION

The field of the invention relates to routing communications through networks and, more specifically, to transmitting communications to mobile stations operating in these networks.

### BACKGROUND OF THE INVENTION

Communications are exchanged between mobile stations in modern communication networks in various ways. For instance, in some systems, such as cellular phone systems, messages are typically exchanged only between two users. In other systems, such as some Push-to-Talk (PTT) systems, multicast or broadcast communications are transmitted to multiple mobile stations at the same time.

When multicast communications are made to members of a multicast group, it is advantageous to provide a high data rate associated with these communications. Offering a high data rate typically facilitates a more timely and efficient communication exchange than can be provided by using a lower data rate. However, the multicast communication data rate is affected by and depends upon the user having the worst channel condition in the multicast group. Consequently, the data rate is typically set to a conservative lower value in order to handle the worst expected user channel conditions.

In current systems, the data rate is sometimes increased by using feedback, such as negative acknowledgement (NACQ) messages, Channel Quality Indicator (CQI) reports, or Layer 2/3 (L2/3) messages, indicating poor channel quality. In these approaches, users identified as having poor quality conditions are removed from the multicast group and/or are placed on a dedicated channel in order to increase the data rate for the remaining members of the multicast group. Unfortunately, while these approaches sometimes increase the data rate for members of the multicast group, they also require the commitment of significant additional resources and thereby increase the costs of the system.

### BRIEF DESCRIPTION OF THE DRAWINGS

FIG. 1 is a system for relaying multicast communications to a mobile station according to embodiments of the present invention;

FIG. 2 is one example of an approach for relaying multicast communications to a mobile station according to embodiments of the present invention;

FIG. 3 is another example of an approach for relaying multicast communications to a mobile station according to embodiments of the present invention;

FIG. 4 is another example of an approach for relaying multicast communications to a mobile station according to embodiments of the present invention; and

FIG. 5 is an example of a base station that facilitates the relaying of multicast communications according to embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method for multicasting allow a mobile station to receive multicast communications when sub-optimal operating conditions exist at the mobile station. The approaches described herein do not require the use of significant amounts of system resources and, consequently, allow for communications to be relayed to a mobile station in an efficient and cost-effective manner.

In many of these embodiments, first and second mobile stations are operating within a network and the second mobile station is receiving multicast communications. A base station within the network determines whether the first mobile station should receive multicast communications. The determination may be made, for instance, by analyzing the operating conditions at the mobile station. Alternatively, a request may be received at the base station from the first mobile station to send a multicast communication using the second mobile station.

A control message is then sent to the first mobile station, second mobile station, or both. The control message initiates a mobile relay of the multicast communications received at the second mobile station to the first mobile station via a proximal communication technology.

The proximal communication technology may be selected from one or more types. For example, the proximal communication technology may be Bluetooth technology, Wireless Fidelity (WiFi) technology (such as but not limited to the I.E.E.E. 802.11 family of proximal technology protocols and standards), or Wireless Local Area Network (WLAN) technology. Other examples of proximal communication technologies are possible.

The determination of whether the mobile station should receive multicast communications may include determining whether poor communication conditions exist at the mobile station. For example, the poor communication condition may indicate a poor channel condition or a downlink overload condition. Other examples of poor communication conditions are possible.

In others of these embodiments, the base station or some other entity may determine the identities of the proximal neighbors of the first mobile station based upon a relative location determination of the first and second mobile stations. The proximal communication capability of the first and second mobile stations may also be determined. This information may be used to aid in the relaying in the multicast communications to the mobile stations.

In still other embodiments, it may be determined whether the mobile relay of the communications from the second mobile station to the first mobile station should be halted. For instance, conditions may have improved at the first mobile station such that the relay can be halted. Once a determination has been made that conditions have improved, the relay may be halted.

In still other approaches, conditions at the second mobile station may be analyzed by the base station or some other entity. This analysis may determine when the second mobile station can no longer relay the multicast communications and identify a third mobile station that can relay the multicast communications. Thereafter, the multicast communications may be relayed from the third mobile station to the first mobile station.

In yet other approaches, following the determination of the proximal location of the first mobile station to a second mobile station, the network can instruct the second mobile station (or alternatively, the first mobile station), to acquire data (retransmission) in case of absence of successful first reception.

Data is received from the proximal mobile station through alternate networks such as Bluetooth or WiFi networks. Diversity combining of data can be achieved through Chase-combining, maximal ratio soft combining, voting, or selection/combining.

Thus, approaches are provided that allow a mobile station to receive multicast communications that are relayed from another mobile station. The approaches described herein do not require the use of significant amounts of system resources and allow communications to be made to a mobile station even when poor communication conditions exist at the mobile station.

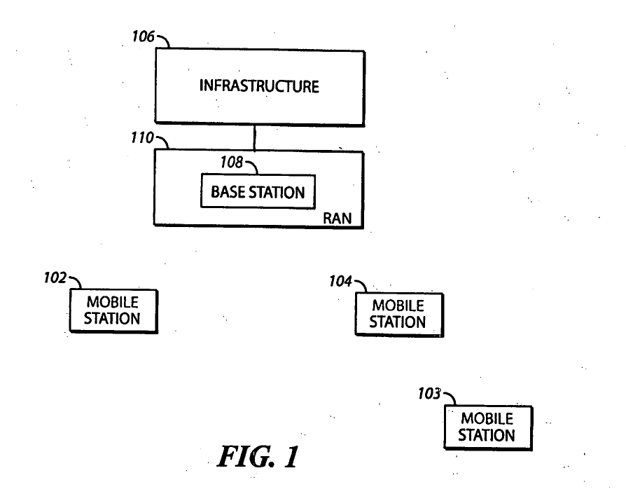

Referring now to FIG. 1, one example of a system for multicasting information to a mobile station is described. Mobile stations 102, 103, and 104 are coupled to a Radio Access Network (RAN) 110. The mobile stations 102, 103, and 104 may be any type of mobile communication device such as cellular telephones, pagers, mobile computers, or personal digital assistants (PDAs). Other examples of mobile stations are possible.

In the current example, the RAN 110 includes a base station 108. The base station 108 provides functionality allowing the mobile stations 102, 103, and 104 to communicate with each other and with a telecommunication infrastructure 106. The base station 108 may also provide proximal network technology so that the mobile stations 102, 103, and 104 may communicate with each other using this technology. For example, the proximal communication technology may be Bluetooth technology, Wireless Fidelity (WiFi) technology, and Wireless Local Area Network (WLAN) technology. In addition, other elements both within the RAN 110 and/or outside the RAN 110 may be used to provide the proximal communication technology. For example, the proximal communication technology may be provided at various servers, access points, or other network elements as known in the art.

The infrastructure 106 may include servers, switches, and other network elements (not shown) that allow the mobile stations 102, 103, and 104 to communicate with each other, other mobile stations outside the coverage area of the base station 108, and other networks. For example, the infrastructure 106 may be coupled to a public telephone system or the Internet (not shown).

In one example of the operation of the system of FIG. 1, it is determined at the base station 108 whether the mobile station 102 should receive multicast communications forwarded to it by one of the other mobile stations 103 or 104. In this example, multicast communications are being broadcast and received at the mobile stations 103 and 104, but are not being received at the mobile station 102.

The determination of whether the mobile station 102 should receive multicast communications may be made by ascertaining whether a poor communication condition exists at the mobile station 102. The poor communication condition may be a poor channel condition or a downlink overload condition. Other examples of poor communication conditions may also be used in the determination. Alternatively, the mobile station 102 may determine it needs to receive multicast communications and the mobile station 102 may send a request to the base station 108 indicating this need.

If the base station 108 determines that the mobile station should receive multicast communications, a control message is sent from the base station 108 to the mobile station 102 and/or the mobile station 104. In one example, a control message may be sent only to the mobile station 102 and, thereafter, a control message may be sent from the mobile station 102 to the second mobile station 104. In another example, the control message may be sent to the mobile station 104 by the base station 108. In either example, the control message initiates a mobile relay of multicast communications received at the mobile station 104 to the mobile station 102 via a proximal communication technology.

In another example of the operation of the system of FIG. 1, the base station 108 may determine the identities of the proximal neighbors of the mobile station 102 based upon a relative location determination of the mobile stations 102 and 104. The proximal communication capability of the mobile stations 102 and 104 may also be determined. This information may be used to facilitate the relaying of communications from mobile station to mobile station.

In still other approaches, after the relay of communications has been initiated, the base station 108 may determine whether the mobile relay from the mobile station 104 to the mobile station 102 should be halted. For example, conditions at the mobile station 102 may improve such that a relay is no longer needed. These conditions may be monitored by the base station 108 or a message may be received from the mobile station 102 indicating that the relay is no longer needed.

In still another example of the operation of the system of FIG. 1, the base station 108 may determine whether the mobile station 104 should no longer relay the multicast communications to other mobile stations. Once this determination has been made, an identity of another mobile station (e.g., mobile station 103) that can relay the multicast communications can be determined by the base station 108. For example, the base station 108 may have a list of suitable mobile stations. Alternatively, the base station 108 may monitor conditions at the other mobile stations and determine suitable mobile stations from the monitored information. Thereafter, multicast communications may be relayed from the mobile station 103 to the mobile station 102.

In another example of the operation of the system of FIG. 1, the overall data rate of the multicast communications may be increased by relaying information to additional users in the group, which includes the mobile stations 102, 103, and 104. For example, it may be desirable that 95 percent of users in the multicast group (e.g., mobile stations 102, 103, and 104) should be able to receive a channel. Alternatively, it may be desirable that all users of the group should be able to receive a channel 95 percent of the time.

To achieve the 95 percent level, the data rate may be decreased from, for example, 500 kbps to 250 kbps and the error protection may be increased (by decreasing the coding rate from ½ to ¼). In addition, with the approaches described herein, the 95 percent level may be achieved by moving one or more users to the group of users that are served by relayed multicast communications, and all users may be able to be served with 500 kbps and ½ coding.

In yet other approaches, following the determination of the proximal location of the mobile station 102 to the mobile station 104, the network can instruct the mobile station 104 (or alternatively, the mobile station 102), to acquire data (retransmission) in case of absence of successful first reception.

Data is received from the proximal mobile station through alternate networks such as Bluetooth or WiFi. Diversity combining of data can be achieved through Chase-combining, maximal ratio soft combining, voting, or selection/combining.

The Chase combining of the direct broadcast packet from the base station 108 to the mobile station 102 with the relayed packet to the mobile station 104 is frequently made using different technologies or different channel coding. If the packet is decoded and received reliably at the mobile station 104, the decoded packet can be relayed to the mobile station 102. If the mobile station 104 is unable to decode the packet correctly, the received soft information can be sent to the mobile station 102. The soft information corresponds to a codeword of the network, and may additionally be encoded for alternate system radio interface protocol. Alternatively, the mobile station 104 can simply embed the undecoded packet as received on the cellular radio interface and embed it in the alternate network protocol and relay it to the mobile station 102 for diversity encoding.

Additional signaling information can be included to assist the mobile station 102 in the process. The mobile station 102 may know what to do with the packet from the mobile station 104 based upon the packet's size, or additional signaling information may be included to direct the mobile station 102 to either take the packet or perform Chase combining. In order to reduce the size of the soft information, the soft information may be quantized via a number of known techniques. For example, a fewer number of bits than usual decoding may be used (e.g., 4 instead of 8). In the extreme case, a single hard value may be sent by slicing each soft value, along with an average (and possible variance) of the set of soft values. This can be applied to multicast and unicast data. In the later case, the mobile station 104 is instructed to simply relay the information to the mobile station 102 with additional information to assist with the combining as necessary. The mobile station 104 is selected based upon better radio conditions and proximity to the mobile station 102.

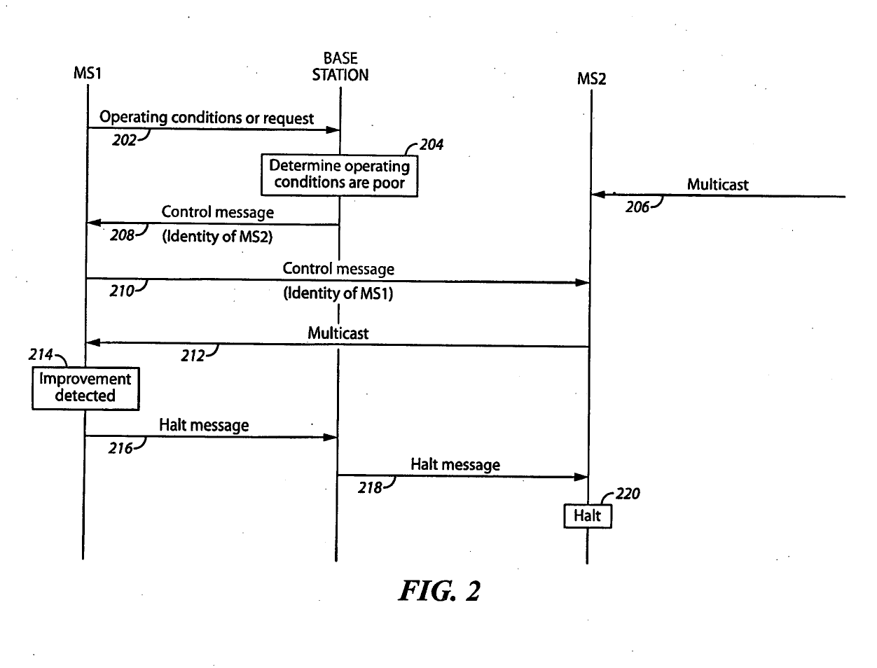

Referring now to FIG. 2, one example of an approach for relaying multicast communications to a mobile station is described. In this example, a first mobile station (MS1) and a second mobile station (MS2) are operating in a network. At step 202, operating conditions of a mobile station are relayed from a first mobile station (MS1) to the base station. At step 204, the base station uses the conditions to determine whether the operating conditions at the first mobile station (MS1) are poor enough so that multicast communications should be relayed to the first mobile station (MS1). For example, the conditions may reach a threshold level indicating poor operating conditions exist. Alternatively, a request to send multicast communications may be sent from the first mobile station (MS1) to the base station at step 202 and step 204 may be omitted. The request may be a request to send multicast communications and the base station may determine how to process the request. Alternatively, the request may be a request to have another mobile (identified in the request) relay the communications. At step 206, multicast communications are received at a second mobile station (MS2).

At step 208, assuming it was determined that the operating conditions at the first mobile station (MS1) were poor, a control message is sent from the base station to the first mobile station (MS1). The control message specifies the identity of the second mobile station (MS2). At step 210, a control message is sent from the first mobile station (MS1) to the second mobile station (MS2). This control message specifies the identity of the first mobile station (MS1). The control message may be transmitted via the base station or directly from MS1 to MS2.

At step 212, the multicast communications are relayed from the second mobile station (MS2) to the first mobile station (MS1) using a proximal communication technology. At step 214, it is detected at the first mobile station (MS1) that an improvement in the operating conditions at the first mobile station has occurred. At step 216, a halt relaying message is sent from the first mobile station to the base station and, at step 218, from the base station to the second mobile station (MS2). At step 220, relaying of the multicast communications is halted.

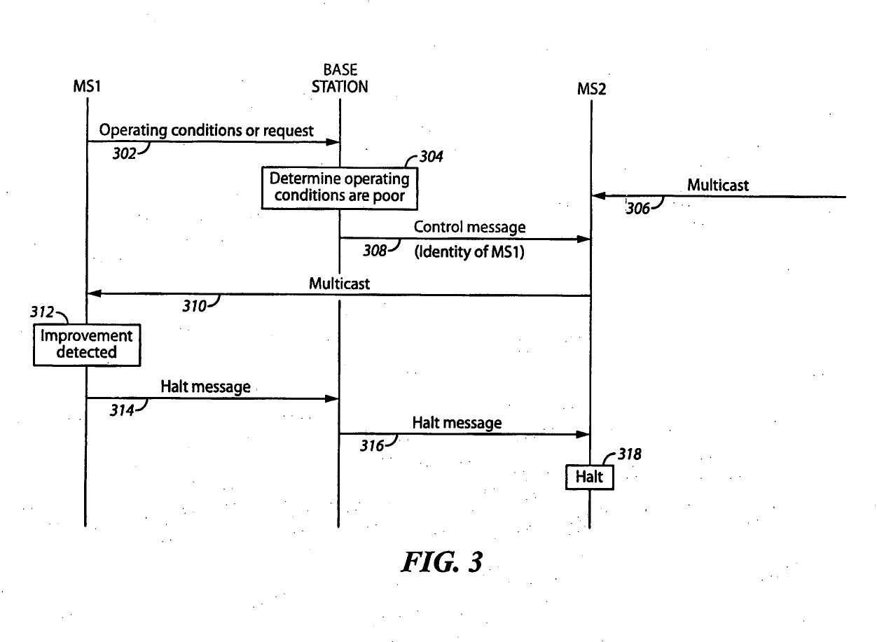

Referring now to FIG. 3, another example of an approach for relaying multicast communications to a mobile station is described. In this example, a first mobile station (MS1) and a second mobile station (MS2) are operating in a network. At step 302, operating conditions of a mobile station are relayed from a first mobile station (MS1) to the base station. At step 304, the base station uses the conditions to determine whether the operating conditions at the first mobile station (MS1) are poor enough so that multicast communications should be relayed to the first mobile station (MS1). Altematively, a request to send multicast communications may be sent from the first mobile station (MS1) to the base station at step 302 and step 304 may be omitted. The request may be a request to send multicast communications and the base station may determine how to process the request. Alternatively, the request may be a request to have another mobile (identified in the request) relay the communications. At step 306, multicast communications are received at a second mobile station (MS2).

At step 308, assuming it was determined that the operating condition were poor, a control message is sent from the base station to the second mobile station (MS2). The control message specifies the identity of the first mobile station (MS1). At step 310, the multicast communications are relayed from the second mobile station (MS2) to the first mobile station (MS1) using a proximal communication technology.

At step 312, it is detected at the first mobile station (MS1) that an improvement in the operating conditions at the first mobile station has occurred. At step 314, a halt relaying message is sent from the first mobile station to the base station and, at step 316, from the base station to the second mobile station (MS2). At step 318, the relaying of the multicast communications is halted.

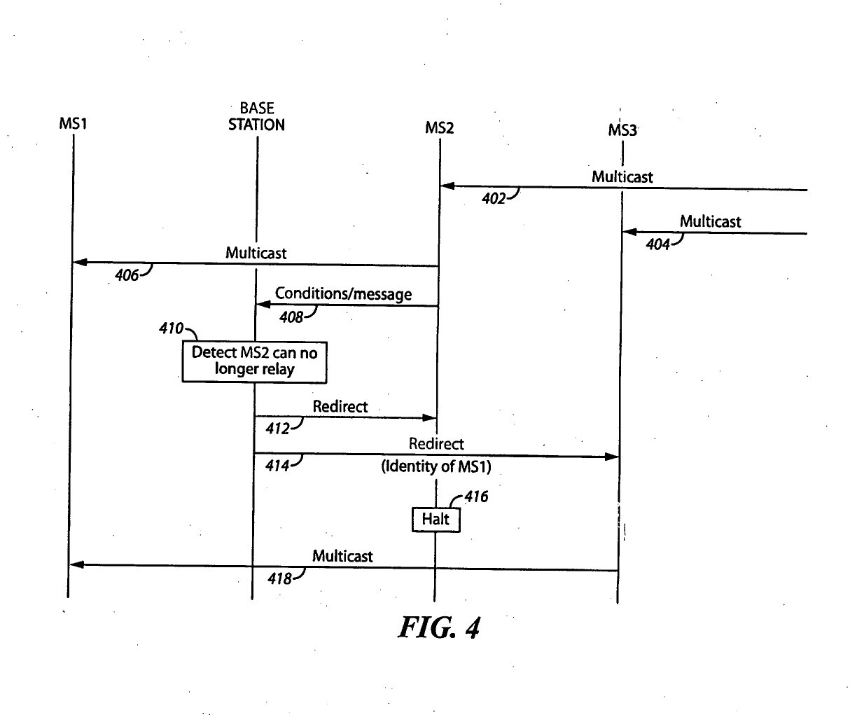

Referring now to FIG. 4, still another example of an approach for relaying multicast communications to mobile stations is described. In this example, a first mobile station (MS1), a second mobile station (MS2), and a third mobile station (MS3) are operating in a network. At step 402, multicast communications are received at the second mobile station (MS2) and, at step 404, the multicast communications are received at the third mobile station (MS3). At step 406, the multicast communications are relayed from the second mobile station (MS2) to the first mobile station (MS1).

At step 408, the base station receives information from the second mobile station (MS2) indicating that the second mobile station (MS2) can no longer relay the multicast communications. For example, the second mobile station (MS2) may supply conditions or a message indicating that the second mobile station (MS2) can no longer relay the multicast communications. At step 410, the base station determines that the second mobile station (MS2) can no longer relay the communications. For example, the base station may analyze the control message and/or the conditions received from the second mobile station (MS2).

At step 412, the base station transmits a redirect message to the second mobile station (MS2). At step 414, the base station transmits a redirect message to the third mobile station (MS3). At step 416, the second mobile station (MS2) halts the forwarding of the multicast communications. At step 418, the multicast communications are forwarded from the third mobile station (MS3) to the first mobile station (MS1).

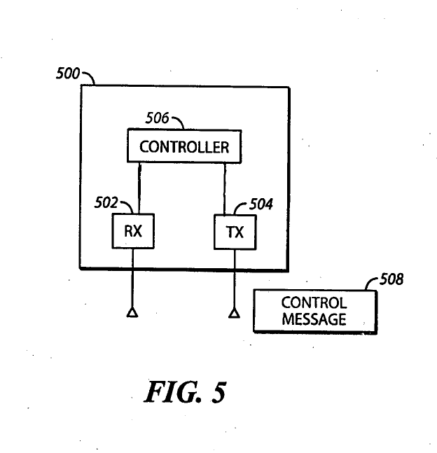

Referring now to FIG. 5, one example of a base station 500 that is utilized to relay multicast communications is described. The base station 502 includes a receiver 502, transmitter 504, and a controller 506.

The controller 506 is programmed to determine from signals received at the receiver 502 that a first mobile station should receive multicast communications. The controller 506 is further programmed to transmit a control message 508 at the output of the transmitter 504 to the first mobile station and/or a second mobile station. The control message 508 causes a mobile relay of the multicast communications received at the second mobile station to the first mobile station via a proximal communication technology.

Thus, approaches are provided that allow a mobile station to receive relayed communications from mobile stations. The approaches described herein do not require the use of significant amounts of system resources, but still allow communication to be maintained with mobile stations, even when operating conditions deteriorate at these mobile stations.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of delivering communications to mobile stations comprising:
at a base station:
determining whether a first mobile station should receive multicast communications; and
sending a control message to at least one of the first mobile station and a second mobile station, the control message initiating a mobile relay of multicast communications received at the second mobile station to the first mobile station via a proximal communication technology.

2. The method of claim 1 wherein initiating a mobile relay of the multicast communications via a proximal communication technology comprises relaying the multicast communications via at least one proximal communication technology selected from a group comprising: Bluetooth technology, Wireless Fidelity (WiFi) technology, and Wireless Local Area Network (WLAN) technology.

3. The method of claim 1 wherein determining whether a first mobile station should receive multicast communications comprises determining whether a poor communication condition exists at the first mobile station.

4. The method of claim 3 wherein determining whether a poor communication condition exists comprises determining whether at least one poor communication condition exists, the at least one poor communication condition being selected from a group comprising: a poor channel condition and a downlink overload condition.

5. The method of claim 1 wherein determining whether a first mobile station should receive multicast communications comprises determining proximal neighbors of the first mobile station based upon a relative location determination of the first and second mobile stations and a proximal communication capability of the first and second mobile stations.

6. The method of claim 1 further comprising receiving a request from the first mobile station to send a multicast communication using the second mobile station.

7. The method of claim 1 further comprising determining whether the mobile relay should be halted and halting the relay.

8. The method of claim 1 further comprising determining when the second mobile station can no longer relay the multicast communications, determining a third mobile station that can relay the multicast communications, and relaying the multicast communications from the third mobile station to the first mobile station.

9. The method of claim 1 wherein sending a control message comprises sending a control message only to the first mobile station and further comprising sending a control message from the first mobile station to the second mobile station.

10. A method of delivering communications to mobile stations comprising:
at a first mobile station:
receiving control signals indicating that a second mobile station desires to receive multicast communications;
receiving the multicast communications; and
relaying the multicast communications to the second mobile station via a proximal communication technology.

11. The method of claim 10 wherein receiving the control signals comprises receiving control signals from a base station.

12. The method of claim 10 wherein receiving the control signals comprises receiving control signals from the second mobile station.

13. The method of claim 10 wherein relaying the multicast communications comprises relaying the communications via at least one proximal communication technology, the at least one proximal communication technology selected from a group comprising: Bluetooth technology, Wireless Fidelity (WiFi) technology, and Wireless Local Area Network (WLAN) technology.

14. The method of claim 10 further comprising receiving an indication that relaying the multicast communications should be halted and halting the relaying of the multicast communications.

15. A base station comprising:
a receiver having an input;
a transmitter having an output; and
a controller coupled to the receiver and the transmitter, the controller being programmed to determine from signals received at the input of the receiver that a first mobile station should receive multicast communications, the controller being further programmed to transmit a control message at the output of the transmitter to at least one of the first mobile station and a second mobile station, the control message causing a mobile relay of the multicast communications received at the second mobile station to the first mobile station via a proximal communication technology.

16. The base station of claim 15 wherein the proximal communication technology is selected from a group comprising: Bluetooth technology, Wireless Fidelity (WiFi) technology, and Wireless Local Area Network (WLAN) technology.

17. The base station of claim 15 wherein the controller is programmed to determine that a poor communication condition exists at the first mobile station from the signals received at the input of the receiver.

18. The base station of claim 17 wherein the poor communication condition is selected from a group comprising: a poor channel condition and a downlink overload condition.

19. The base station of claim 15 wherein the controller is further programmed to determine that the relaying of the multicast communications should be halted from the signals received at the input of the receiver and to transmit a halt command at the output of the transmitter to halt the relaying of the multicast communications at the second mobile station.

20. The base station of claim 15 wherein the controller is further programmed to determine when the second mobile station can no longer relay the multicast communications, to determine a third mobile station that can relay the communications, and to send a control signal to the third mobile station to initiate relaying of the multicast communications from the third mobile station to the first mobile station.
